(19) United States
(12) Patent Application Publication
(10) Pub. No.: US 2025/0138783 A1
(43) Pub. Date: May 1, 2025

(54) MULTIPLY AND ACCUMULATE UNITS AND METHODS

(71) Applicant: MemryX Incorporated, Ann Arbor, MI (US)

(72) Inventors: Chester LIU, Ann Arbor, MI (US); Timothy WESLEY, Ann Arbor, MI (US)

(21) Appl. No.: 19/008,449

(22) Filed: Jan. 2, 2025

Related U.S. Application Data
(63) Continuation-in-part of application No. 18/109,788, filed on Feb. 14, 2023.
(60) Provisional application No. 63/310,031, filed on Feb. 14, 2022.

(51) Int. Cl. G06F 7/523; G06F 7/50

(52) U.S. Cl. CPC G06F 7/523; G06F 7/50

(57) ABSTRACT

A multiply and accumulate (MAC) unit can directly load group brain float encoded values into the MAC. The MAC unit can also include shared exponent processing. The MAC unit can also include a plurality of multiply units with shared alignment logic, and a plurality of accumulation units with shared normalization logic. The MAC unit can also implement delayed normalization.

### CROSS-REFERENCE TO RELATED APPLICATIONS

This is a continuation-in-part of U.S. patent application Ser. No. 18/109,788 filed Feb. 14, 2023, which claims the benefit of U.S. Provisional Patent Application No. 63/310,031 filed Feb. 14, 2022, both of which are incorporated herein in their entirety.

### BACKGROUND OF THE INVENTION

Computing systems perform calculations on numbers encoded using various encoding schemes. One common encoding scheme is the Institute of Electrical and Electronics Engineers (IEEE) 32-bit single-precision floating point number encoding (IEEE 754), which encodes a number using 1-bit for the sign, 8-bits for the exponent, and 23-bits for the mantissa as illustrated in FIG. 1. Another encoding scheme is the Brain Float (BF) encoding standard, which encodes a number using 1-bit for the sign, 8-bits for the exponent, and 7 bits for the mantissa as illustrated in FIG. 2.

Yet another encoding scheme, referred to as Group Brain Float (Group BF or GBF) encoding, involves a modification of the Brain Float (BF) encoding standard to encode a plurality of numbers. In the Group BF, the plurality of numbers are encoded with a common 8-bit exponent, and a separate 1-bit sign and 8-bit mantissa for each respective number, as illustrated in FIG. 3. The 8-bit mantissa encodes a value with an explicit leading bit. The group size of the Group BF encoding indicates the number of numbers encoded together. For example, a Group BF encoding having a group size of six, encodes six numbers using a common 8-bit exponent for all of the six numbers, and 1-bit sign and 8-bit mantissa for each of the six numbers.

Referring now to FIG. 4, a technique for encoding two numbers as a Group BF encoding is illustrated. In the example, a first number 3.14 in decimal format is encoded as 11.001001 in binary format, and a second number −1.414 in decimal format is encoded as −1.0110101 in binary format. Both numbers are normalized by adjusting the exponent such that the largest number's mantissa's leading 1 is on the left of the decimal point. When normalized, the first number 3.14 is normalized as 1.1001001×2¹, and the second number −1.414 is normalized as −1.0110101×2⁰. To encode the two numbers in Group BF, the numbers are adjusted to have a common exponent and the eight most significant bits (MSB) are encoded as the respective mantissas. The Group BF encoded format reduces the amount of storage needed to store the numbers encoded in the Group BF format.

A common calculation in artificial intelligence, machine learning, big data analytics, and the like applications, is the multiply and accumulate (MAC) computation. The conventional MAC unit computes a multiply and accumulation on 32-bit floating point (IEEE 754 encoded) numbers. If the data is stored in Group BF format to reduce the amount of storage, the Group BF numbers are converted back to 32-bit floating point numbers for processing by 32-bit floating point MAC units.

In other embodiments, the MAC unit can be configured to compute directly on Group BF formatted numbers. As illustrated in FIG. 5, the MAC computation of a Group BF encoding having a group size of 2 is illustrated. For computation of two Group BF encodings, the first number in a first Group BF 505 can be loaded into a first register 510 of a MAC unit 500, the first number of a second Group BF 515 can be loaded into a second register 520, the second number of the first Group BF 505 number can be loaded into a third register 525, and the second number of the second Group BF 515 can be loaded into a fourth register 530 of the MAC unit 500. The respective numbers can be multiplied 535 to produce a product. The product 540 can then be accumulated 545 with the previous computation 550 within the MAC unit 500. The individual multiply and accumulate results 550 are then combined as a result Group BF number 555.

In artificial intelligence, machine learning, big data analytics, and the like applications, the processors can include a large number of MAC units to compute large volumes of such computations. To reduce processing latency, energy consumption and the like in systems from smart phones to massive data centers where is a continuing need to improve the performance of processing units such as the MAC units. With the large volume of calculations performed in applications such as artificial intelligence, machine learning, and big data analytics, even very small improvements can provide appreciable improvement in processing latency, energy consumption and the like. Likewise, small changes in the hardware of the MAC units can increase the performance and/or reduce the cost of the computing system hardware.

### SUMMARY OF THE INVENTION

The present technology may best be understood by referring to the following description and accompanying drawings that are used to illustrate embodiments of the present technology directed toward multiply and accumulate (MAC) units and methods of computation.

MAC units, in accordance with aspects of the present technology, can be configured to load group brain float (BF) encoded values directly into the MAC unit. Directly loading group BF encoded values can advantageously eliminate the conversion of group BF values to conventional floating point encoded values thereby reducing processing energy consumption and reducing processing latency. The MAC units can also include shared exponent processing. Shared exponent processing can advantageously reduce the size of the exponent buffers throughout the MAC unit. The MAC units can also include a plurality of multiply units with shared alignment logic. Sharing the alignment logic between the plurality of multiply units can advantageously reduce the size of the plurality of multiply units. The MAC units can also include a plurality of accumulation units with shared normalization logic. Sharing the normalization logic between the plurality of accumulation units can advantageously reduce the size of the plurality of accumulation units. The MAC units can also implement delayed normalization by the plurality of accumulation units with shared normalization logic. Delay normalization can advantageously reduce processing energy consumption and reduce processing latency.

In one embodiment, a MAC unit can include a first plurality of buffers, a plurality of multiplication units and a plurality of accumulation units. The first plurality of buffers can include a plurality of sign buffers, a plurality of mantissa buffers and a shared exponent buffer to directly receive sets of group brain float (BF) encoded values. The plurality of multiplication units can be configured to perform multiplication computations on sets of BF encoded values of the sets of group BF encoded values in the plurality of input buffers to produce corresponding BF encoded products. The plurality of multiplication units can include shared alignment logic that utilizes the share exponent buffer to maintain a common exponent value of the corresponding BF encoded products. The plurality of accumulation units can be configured to perform accumulation computations on sets of the corresponding BF encoded products to produce corresponding BF encoded accumulation results. The plurality of accumulation units can include shared normalization logic to normalize the sets of the corresponding BF encoded products. The normalization logic can be configured to delay normalization for one or more normalization computation cycles.

In another embodiment, a MAC method can include directly receiving group brain float (BF) encoded values. Sets of the BF encoded values of the group BF encoded values can be multiplied to produce corresponding BF encoded products. The corresponding BF encoded products can be accumulated to produce corresponding BF encoded accumulation results. In one implementation, the sets of BF encoded values of the set of group BF encoded values comprise pixels. The set of group BF encoded values of the pixels can be multiplied with corresponding sets of a plurality of weights to compute a regular convolution of the pixels and the weights. In another implementation, the set of group BF encoded values of the pixels can be multiplied with corresponding sets of a plurality of weights to compute a depthwise convolution of the pixels and the weights. In another implementation, corresponding BF encoded accumulation results can be multiplied with corresponding sets of a plurality of scale values to compute corresponding BF encoded scaled accumulation results. In another implementation, corresponding BF encoded accumulation results can be multiplied with corresponding sets of a plurality of bias values to compute corresponding BF encoded biased accumulation results. In yet another implementation, corresponding BF encoded previous accumulation results can be multiplied with corresponding BF encoded current accumulation results to compute loopback adding.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF DRAWINGS

Embodiments of the present technology are illustrated by way of example and not by way of limitation, in the figures of the accompanying drawings and in which like reference numerals refer to similar elements and in which:

FIG. 1 shows a 32-bit single-precision floating point number encoding scheme according to the conventional art.

FIG. 2 shows a Brain Float encoding scheme according to the conventional art.

FIG. 3 shows a Group Brain Float encoding scheme according to the conventional art.

FIG. 4 illustrates encoding two decimal numbers in a Group Brain Float encoding according to the conventional art.

FIG. 5 shows a multiply and accumulate unit according to the conventional art.

FIG. 6 shows a MAC unit for Group BF computations, in accordance with aspects of the present technology.

FIGS. 7A-7C show a MAC unit for Group BF computations for regular convolutions, in accordance with aspects of the present technology.

FIGS. 8A-8C show a MAC unit for Group BF computations for depthwise convolutions, in accordance with aspects of the present technology.

FIGS. 9A-9C show a MAC unit for Group BF computations for scaling, in accordance with aspects of the present technology.

FIGS. 10A-10C show a MAC unit for Group BF computations for biasing, in accordance with aspects of the present technology.

FIGS. 11A-11C show a MAC unit for Group BF computations for loopback adding, in accordance with aspects of the present technology.

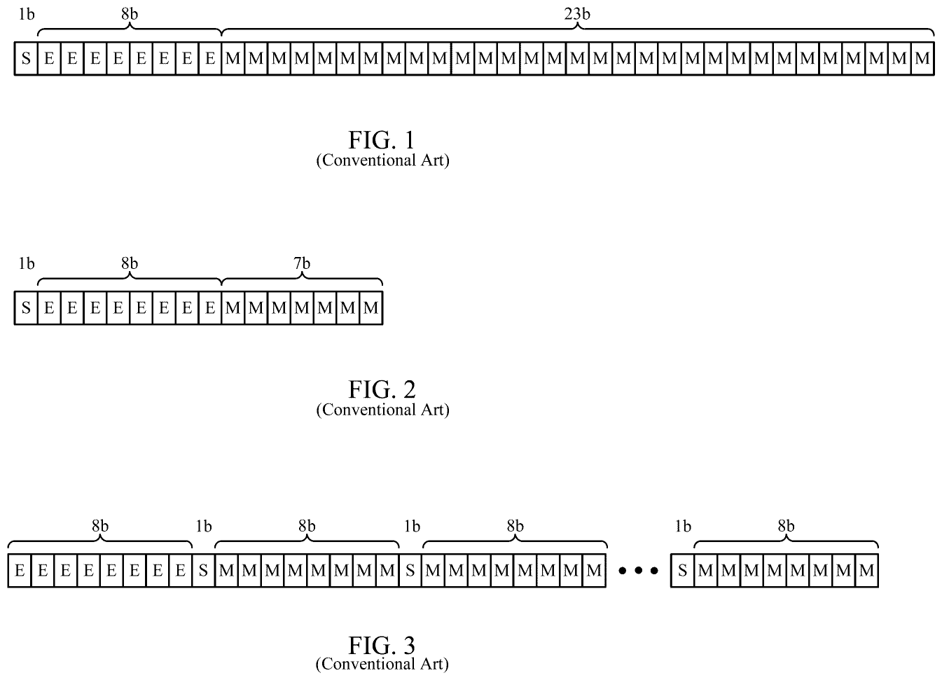

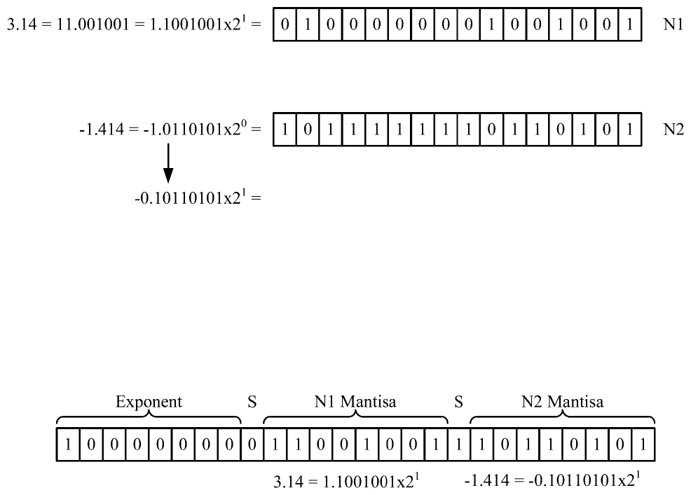

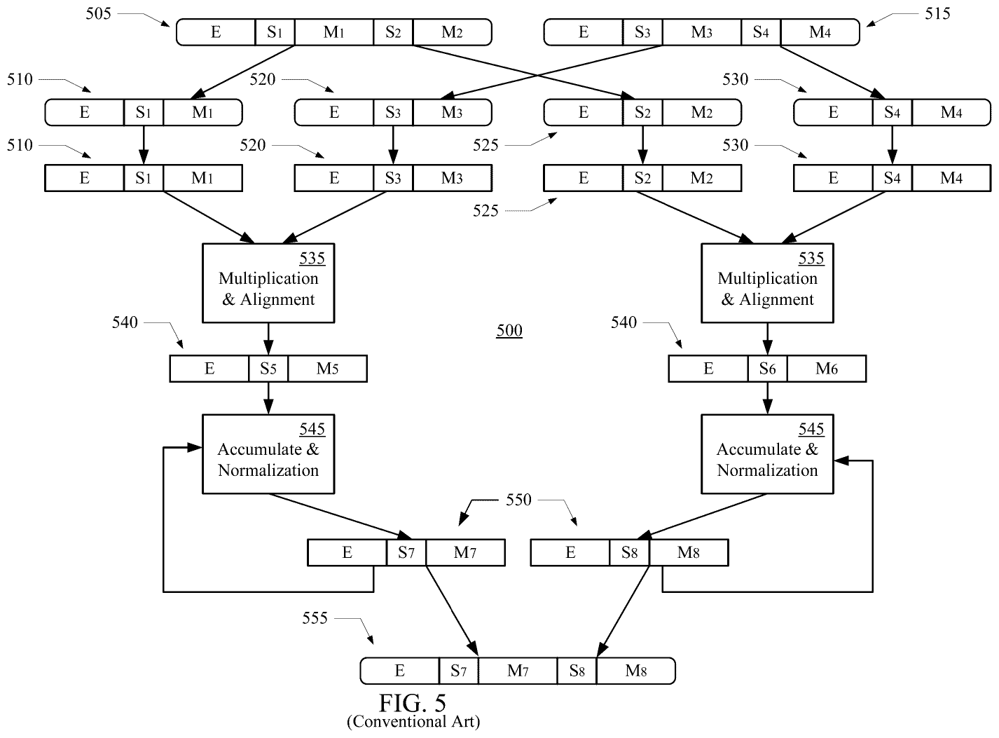

### DETAILED DESCRIPTION OF THE INVENTION

Reference will now be made in detail to the embodiments of the present technology, examples of which are illustrated in the accompanying drawings. While the present technology will be described in conjunction with these embodiments, it will be understood that they are not intended to limit the technology to these embodiments. On the contrary, the present technology is intended to cover alternatives, modifications and equivalents, which may be included within the scope of the invention as defined by the appended claims. Furthermore, in the following detailed description of the present technology, numerous specific details are set forth in order to provide a thorough understanding of the present technology. However, it is understood that the present technology may be practiced without these specific details. In other instances, well-known methods, procedures, components, and circuits have not been described in detail as not to unnecessarily obscure aspects of the present technology.

Some embodiments of the present technology which follow are presented in terms of routines, modules, logic blocks, and other symbolic representations of operations on data within one or more electronic devices. The descriptions and representations are the means used by those skilled in the art to most effectively convey the substance of their work to others skilled in the art. A routine, module, logic block and/or the like, is herein, and generally, conceived to be a self-consistent sequence of processes or instructions leading to a desired result. The processes are those including physical manipulations of physical quantities. Usually, though not necessarily, these physical manipulations take the form of electric or magnetic signals capable of being stored, transferred, compared and otherwise manipulated in an electronic device. For reasons of convenience, and with reference to common usage, these signals are referred to as data, bits, values, elements, symbols, characters, terms, numbers, strings, and/or the like with reference to embodiments of the present technology.

It should be borne in mind, however, that these terms are to be interpreted as referencing physical manipulations and quantities and are merely convenient labels and are to be interpreted further in view of terms commonly used in the art. Unless specifically stated otherwise as apparent from the following discussion, it is understood that through discussions of the present technology, discussions utilizing the terms such as “receiving,” and/or the like, refer to the actions and processes of an electronic device such as an electronic computing device that manipulates and transforms data. The data is represented as physical (e.g., electronic) quantities within the electronic device's logic circuits, registers, memories and/or the like, and is transformed into other data similarly represented as physical quantities within the electronic device.

In this application, the use of the disjunctive is intended to include the conjunctive. The use of definite or indefinite articles is not intended to indicate cardinality. In particular, a reference to “the” object or “a” object is intended to denote also one of a possible plurality of such objects. The use of the terms “comprises,” “comprising,” “includes,” “including” and the like specify the presence of stated elements, but do not preclude the presence or addition of one or more other elements and or groups thereof. It is also to be understood that although the terms first, second, etc. may be used herein to describe various elements, such elements should not be limited by these terms. These terms are used herein to distinguish one element from another. For example, a first element could be termed a second element, and similarly a second element could be termed a first element, without departing from the scope of embodiments. It is also to be understood that when an element is referred to as being “coupled” to another element, it may be directly or indirectly connected to the other element, or an intervening element may be present. In contrast, when an element is referred to as being “directly connected” to another element, there are not intervening elements present. It is also to be understood that the term “and or” includes any and all combinations of one or more of the associated elements. It is also to be understood that the phraseology and terminology used herein is for the purpose of description and should not be regarded as limiting.

Applications such as artificial intelligence, machine learning, big data analytics, and the like perform computations on large amounts of data. A number of techniques are utilized to store the large amount of data and to efficiently perform calculations on the large amount of data. For example, various encoding techniques are utilized to improve storage and/or computation performance by computing devices.

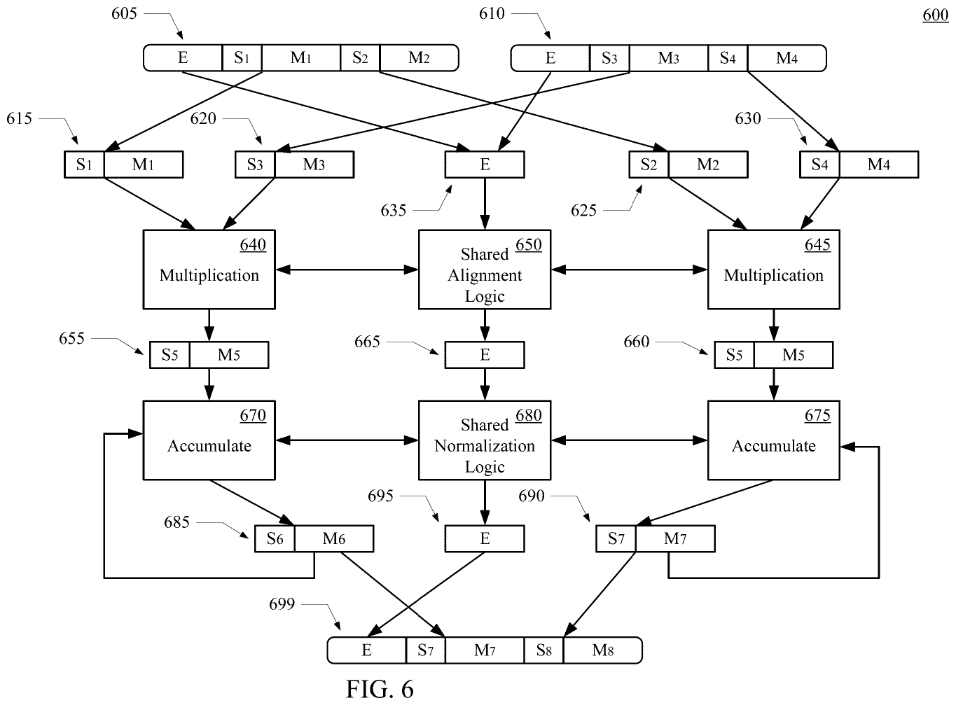

In one embodiment of the present technology, the multiply and accumulate computation of Group BF encoded numbers can share the exponent and can share alignment and normalization logic within the group during computations. Referring now to FIG. 6, a MAC unit for Group BF computations, in accordance with aspects of the present technology, is shown. The MAC unit 600 can be configured to share exponent values during computation to reduce register size. The MAC unit 600 can be further configured to share alignment and normalization logic gates within groups. In one embodiment, two sets of Group BF encoded numbers can be loaded into respective input buffers of MAC unit. For example, two sets of Group BF encoded numbers 605, 610 can be loaded into respective input buffers 615-635 of MAC unit 600 as illustrated in FIG. 6. The MAC unit 600 can include sign/mantissa buffers 615-630 for receiving the sign and mantissa of respective numbers, and a shared exponent buffer 635 for receiving the sign of the respective numbers. The sign/mantissa buffers 615-630 and shared exponent buffer 635 are configured to directly receive the respective signs, mantissas and exponent of the Group BF encoding, without first converting the Group BF to individual BF encodings of the respective numbers. In one implementation, one or more Group BF encodings may be adjusted to align the numbers to the largest sign value of the set of Group BF encodings.

The MAC unit 600 can include a set of multiplication units 640, 645 and shared alignment logic 650. Each multiplication unit 640, 645 can compute products of the sign and mantissas in corresponding sign/mantissa buffers 615-630. For example, a first multiplication unit 640 can compute the product of the sign (S1) and mantissa (M1) of a first number from a first Group BF 605 and the sign (S3) and mantissa (M3) of a first number from a second Group BF 610. Likewise, a second multiplication unit 645 can compute the product of the sign (S2) and mantissa (M2) of a second number from the first Group BF 605 and the sign (S4) and mantissa (M4) of the second number from the second Group BF 610. The exponent of the first and second Group BF encodings 605, 610 can be shared 635, which reduces the amount of buffer need in the MAC unit 600. For example, the buffers may typically be implemented using flipflops that common consume a relatively large amount of space on the integrated circuit die of the MAC unit 600. By sharing, the flip flop count for the exponent can be reduced for example from 16 bits to 8 bits for each stage of buffering. The shared alignment logic 650 can be configured to align the products computed by the respective multiplication units 640, 645 and adjust the shared exponent 635 as necessary. The products and corresponding exponent can be buffered in corresponding product buffers 655, 660 and shared intermediate exponent buffer 665. By sharing the alignment logic 650 between a plurality of multiplication units 640, 645, the logic can be reduced.

The MAC unit 600 can further include a set of accumulation units 670, 675 and shared normalization logic 680. Each accumulation unit 670, 675 can compute the sum of current products and previous accumulation values in corresponding product buffers 655, 660 and accumulation buffers 685, 690. The current sums are buffered in the accumulation buffers 685, 690. For example, a first accumulation unit 670 can compute the sum of the current product in a first product buffer 655 with the previous accumulated value in a first accumulation buffer 685, and the current accumulated value can be stored back in the first accumulation buffer 685. Likewise, a second accumulation unit 675 can compute the sum of the current product in the second product buffer 660 with the previous accumulated value in a second accumulation buffer 690. The shared normalization logic 680 can be configured to normalize the current accumulated value, which can then be stored back in the corresponding accumulation buffers 685, 690. The shared normalization logic 680 can further adjust the shared intermediate exponent 665 as necessary before storing in the shared accumulated exponent buffer 695. By sharing the normalization logic 680 between a plurality of accumulation units, the logic can be reduced.

The MCE unit 600 can iteratively perform a plurality of multiply and accumulate operations to compute a final result for output in as a Group BF formatted result 699. In one implementation, the content of the accumulation buffer 685, 690 and shared accumulated exponent buffer 695 can be output directly in a group BF format.

In one implementation, the shared alignment logic and shared normalization logic can perform alignment and normalization on each respective multiplication operation and accumulation operation. In another implementation, alignment and normalization can be delayed during Group BF computations. The buffers 655-665, 685-690 associated with the mantissas and exponents can include one or more extra bits to permit the delay of alignment and normalization. Adding one or two bits can allow for a partial reduction in the buffer size, while also reducing the repeated alignment and/or normalization computations.

Although the MAC unit 600 is shown for computing Group BF encodings of a group size of two, it is appreciated that the plurality of multiplication and accumulation units and associated registers can be increased to compute Group BF encoded numbers having a group size of greater than two, while utilizing the shared exponent and shared alignment and normalization logic.

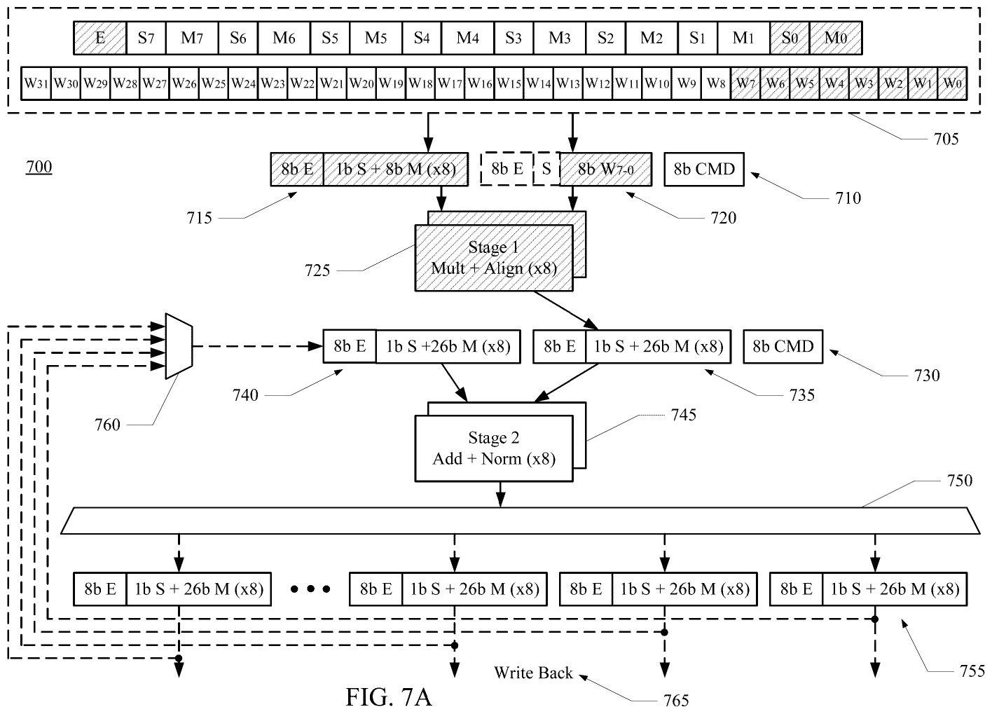

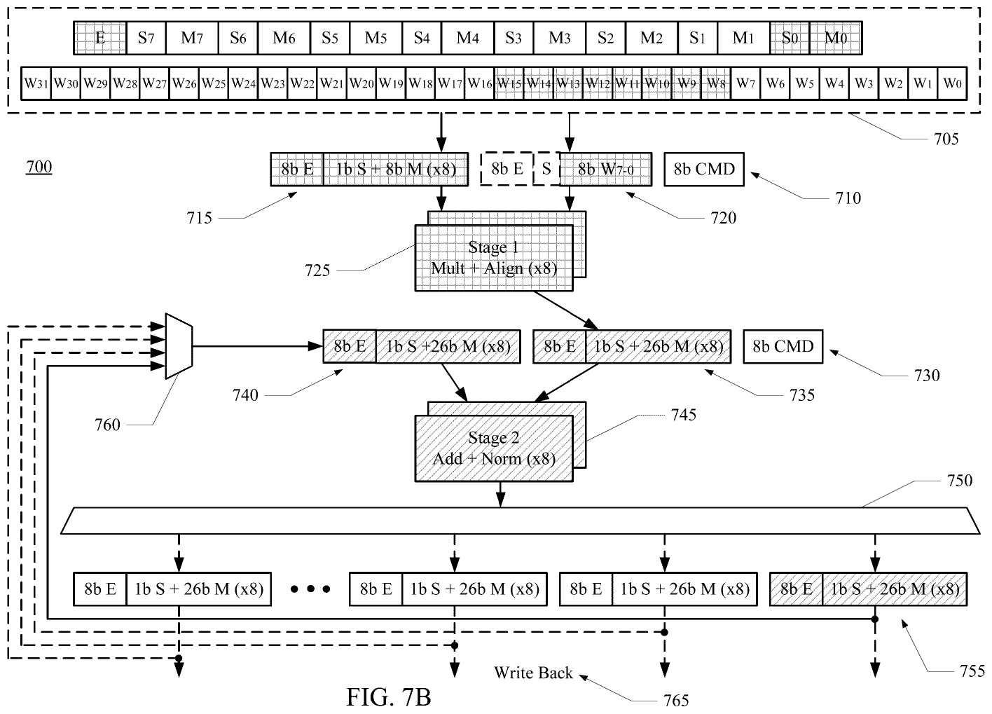

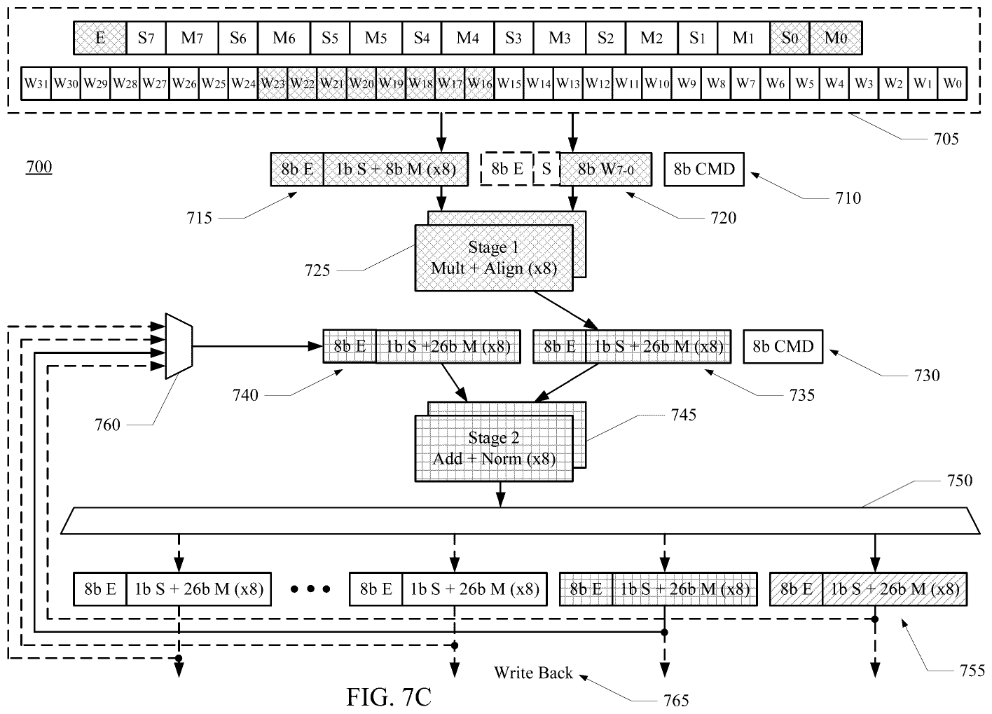

Referring now to FIGS. 7A-7C, a MAC unit for Group BF computations, in accordance with aspects of the present technology, is shown. The MAC unit 700 can be configured to compute a regular convolution of a set of Group BF encoded values with a set of weight values. For instance, the MAC unit 700 can be configured to compute a multiply and accumulation function of Group BF encoded pixel values and a set of weight values 705. The regular convolution can be performed in response to a corresponding command. In one implementation, the command can include a series of microinstructions 710 for executing computations by a plurality of multiplication and alignment units 725, and a series of microinstructions 730 for executing computations by a plurality of addition and normalization units 745.

The pixel values can be encoded in a Group BF of a group size of eight, with a common exponent of 8-bit (8b), and a 1-bit (1b) sign and 8-bit (8b) mantissa for each pixel. The weights can each be encoded by 8-bits (8b). The MAC unit 700 can include a set of eight multiply units with shared alignment logic 725, a set of eight accumulation units with shared normalization logic 745, associated buffers 715, 720, 735, 740, 755 and selection logic (e.g., de-multiplexor and multiplexor) 750, 760. The associated buffers are shown with separate exponent buffers, but can alternatively implement shared exponent buffers. To compute a regular convolution, an exponent (E), first sign (S₀) and first mantissa (M₀) representing, for example, a first pixel value can be loaded as eight copies into exponent buffers, and first set of eight sign/mantissa buffers 715. A first set of eight weights (W₀-W₇) can be loaded into a second set of eight mantissa buffers 720. It is to be appreciated that the weight values do not include a sign or exponent. The set of multiply units with shared alignment logic 725 can compute the product of the first pixel value with each of the first eight weight values in a first computation cycle (e.g., a set of one or more processing clock cycles), as illustrated in FIG. 7A.

In a second computation cycle illustrated in FIG. 7B, the first set of product values can be loaded into a corresponding first set of intermediate buffers 735, and a set of eight first accumulation values (e.g., initially set to a zero value) 755 can be loaded 760 into a corresponding second set of intermediate buffers 740. The set of accumulation units with shared normalization logic 745 can compute the accumulation of the current product values 735 with the previous accumulation values 740 during the second computation cycle. During the second computation cycle, the first pixel values (E, S₀, M₀) and a second set of eight weight values (W₈-W₁₅) can be loaded into the corresponding buffers, and the set of multiply units with shared alignment logic 725 can compute the product of the first pixel value with each of the second set of eight weight values.

In a third computation cycle illustrated in FIG. 7C, the first set of accumulation values can be loaded 750 into a corresponding first set of accumulation buffers 755. During the second computation cycle, the second set of product values can be loaded into the corresponding first set of intermediate buffers 735, and a set of eight second accumulation values (initially set to a zero value) 755 can be loaded 760 into the corresponding second set of intermediate buffers 740. During the second computation cycle, the set of accumulation units with shared normalization logic 745 can compute the accumulation of the current product values 735 with the previous accumulation values 740. During the third computation cycle, the first pixel values (E, S₀, M₀) and a third set of eight weight values (W₁₆-W₂₃) can be loaded into the corresponding buffers, and the set of multiply units with shared alignment logic 725 can compute the product of the first pixel value with each of the third set of eight weight values.

The process can continue for computing the regular convolution of the combination of the eight pixel values with the set of weight values 705. The set of multiply units with shared alignment logic 725 can provide for shared processing of the exponent to maintain a common exponent. Similarly, the set of accumulation units with shared normalization logic 745 can provide for normalizing the accumulated values so that the leading value of 1 can be explicitly encoded using group BF encoding. Furthermore, the accumulation buffers can include one or more extra bits to provide for delayed normalization to reduce the number of times normalization is performed during multiply and accumulation cycles. After the regular convolution of the combination of the eight pixel values with the set of weight values 705 is completed the resulting accumulated values in the accumulation buffers 755 can be written back 765 to memory.

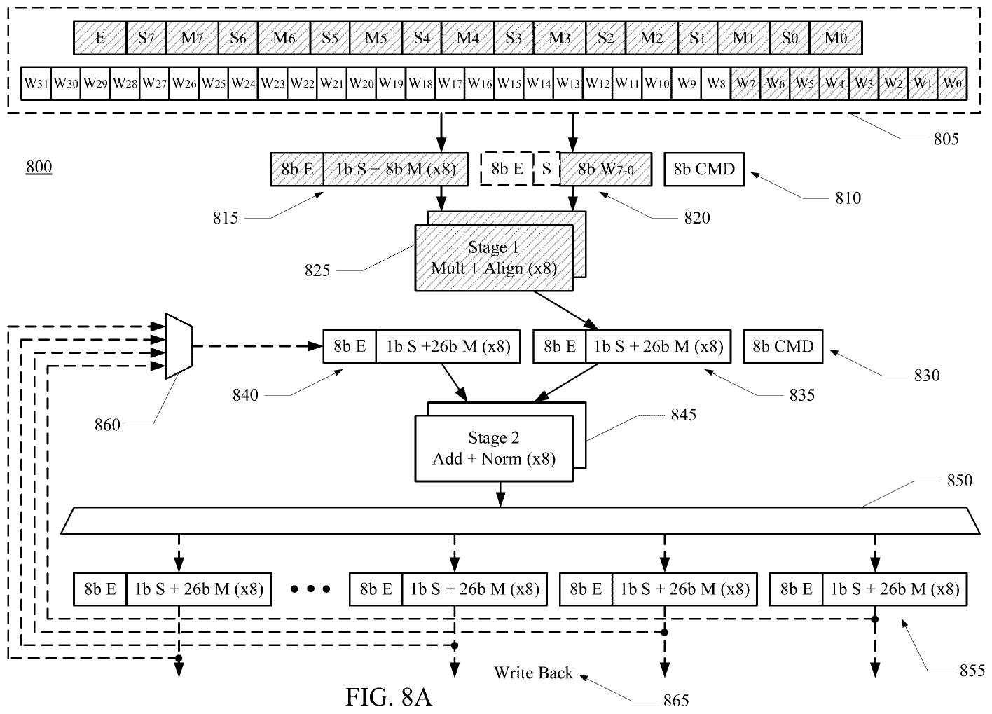

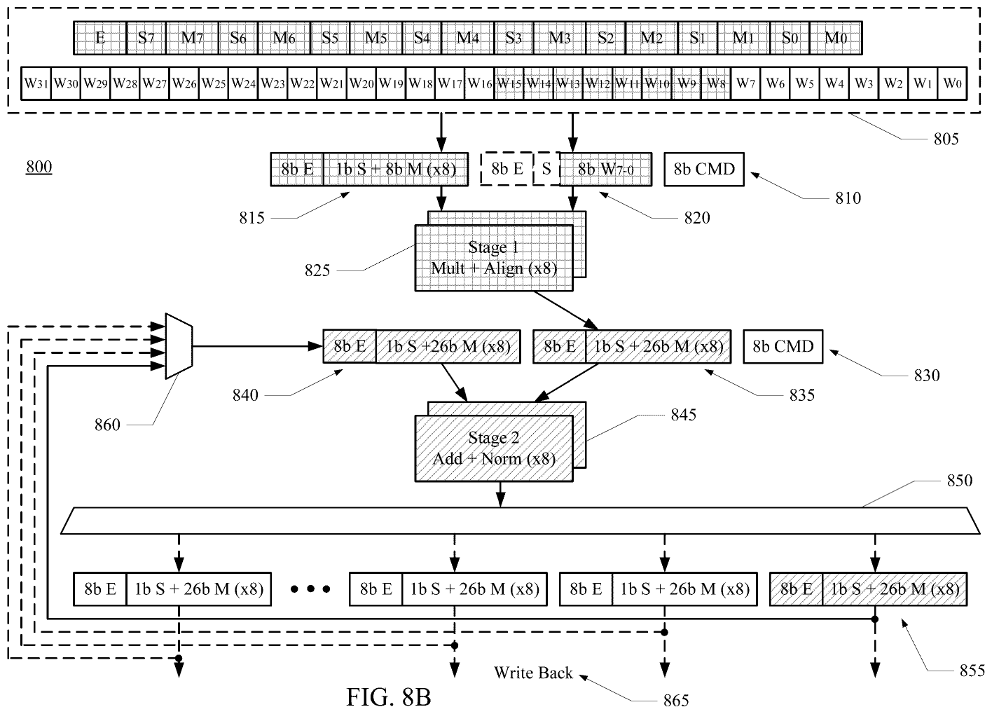

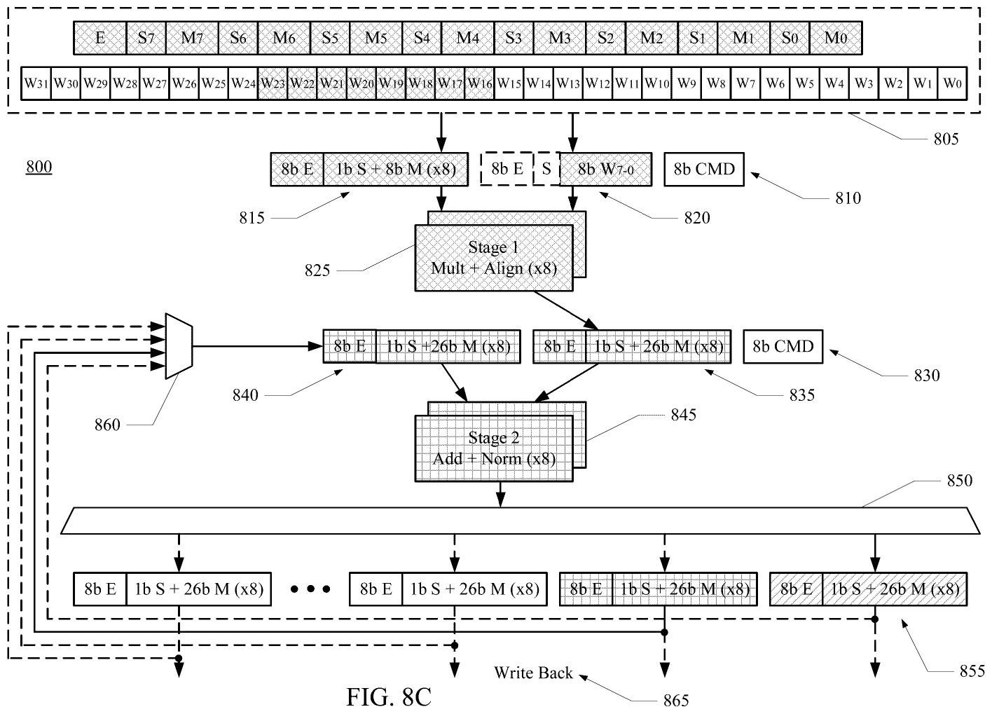

Referring now to FIGS. 8A-8C, a MAC unit for Group BF computations, in accordance with aspects of the present technology, is shown. The MAC unit 800 can be configured to compute a depthwise convolution of a set of Group BF encoded values with a set of weight values. For instance, the MAC unit 800 can be configured to compute a multiply and accumulation function of Group BF encoded pixel values and set of weight values 805. The depthwise convolution can be performed in response to a corresponding command. In one implementation, the command can include a series of microinstructions 810 for executing computations by a plurality of multiplication and alignment units 825, and a series of microinstructions 830 for executing computations by a plurality of addition and normalization units 845.

Again, the pixel values can be encoded in a Group BF of a group size of eight, with a common exponent of 8-bit (8b), and a 1-bit (1b) sign and 8-bit (8b) mantissa for each pixel. The weights can each be encoded by 8-bits (8b). The MAC unit 800 can include a set of eight multiply units with shared alignment logic 825, a set of eight accumulation units with shared normalization logic 845, associated buffers 815, 820, 835, 840, 855 and selection logic (e.g., de-multiplexor and multiplexor) 850, 860. The associated buffers are shown with separate exponent buffers, but can alternatively implement shared exponent buffers. To compute a depthwise convolution, an exponent (E), and sets of sign (S₀) and mantissa (M₀) values representing, for example, of a set of eight pixel values can be loaded into a shared exponent buffer, and sets of eight sign/mantissa buffers 815. A first set of eight weights (W₀-W₇) can be loaded into a second set of eight mantissa buffers 820. It is to be appreciated that the weight values do not include a sign or exponent. The set of multiply units with shared alignment logic 825 can compute the product of the eight pixel values with each of the first eight weight values in a first computation cycle (e.g., a set of one or more processing clock cycles), as illustrated in FIG. 8A.

In a second computation cycle illustrated in FIG. 8B, the first set of product values can be loaded into a corresponding first set of intermediate buffers 835, and a set of eight first accumulation values (e.g., initially set to a zero value) 855 can be loaded 860 into a corresponding second set of intermediate buffers 840. The set of accumulation units with shared normalization logic 845 can compute the accumulation of the current product values 835 with the previous accumulation values 840 during the second computation cycle. During the second computation cycle, the eight pixel values and a second set of eight weight values (W₈-W₁₅) can be loaded into the corresponding buffers 815, 820, and the set of multiply units 825 can compute the product of the eight pixel values with each of the second set of eight weight values.

In a third computation cycle illustrated in FIG. 8C, the first set of accumulation values can be loaded 850 into a corresponding first set of accumulation buffers 855. During the second computation cycle, the second set of product values can be loaded into the corresponding first set of intermediate buffers 835, and a set of eight second accumulation values (initially set to a zero value) 855 can be loaded 860 into the corresponding second set of intermediate buffers 840. During the second computation cycle, the set of accumulation units with shared normalization logic 845 can compute the accumulation of the current product values 835 with the previous accumulation values 840. During the second computation cycle, the eight pixel values and a third set of eight weight values (W₁₆-W₂₃) can be loaded into the corresponding buffers 815, 820, and the set of multiply units with shared alignment logic 825 can compute the product of the eight pixel values with each of the third set of eight weight values.

The process can continue for computing the depthwise convolution of the combination of the eight pixel values with the set of weight values 805. The set of multiply units with shared alignment logic 825 can provide for shared processing of the exponent to maintain a common exponent. Similarly, the set of accumulation units with shared normalization logic 845 can provide for normalizing the accumulated values so that the leading value of 1 can be explicitly encoded using group BF encoding. Furthermore, the accumulation buffers can include one or more extra bits to provide for delayed normalization to reduce the number of times normalization is performed during multiply and accumulation cycles. After the depthwise convolution of the combination of the eight pixel values with the set of weight values 805 is completed the resulting accumulated values in the accumulation buffers 855 can be written back 865 to memory.

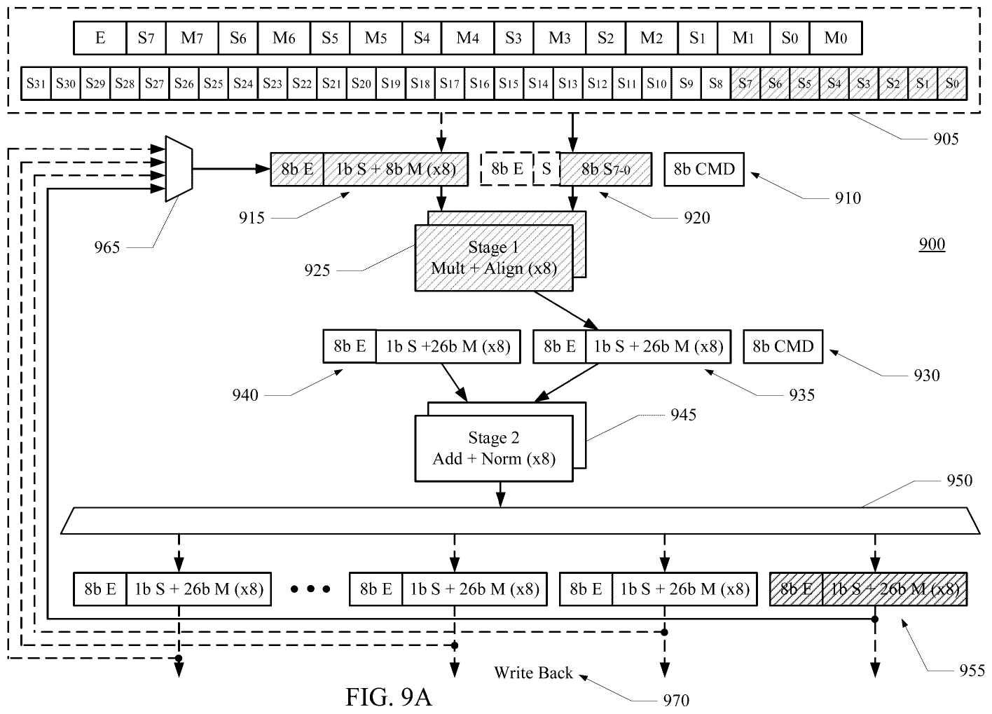

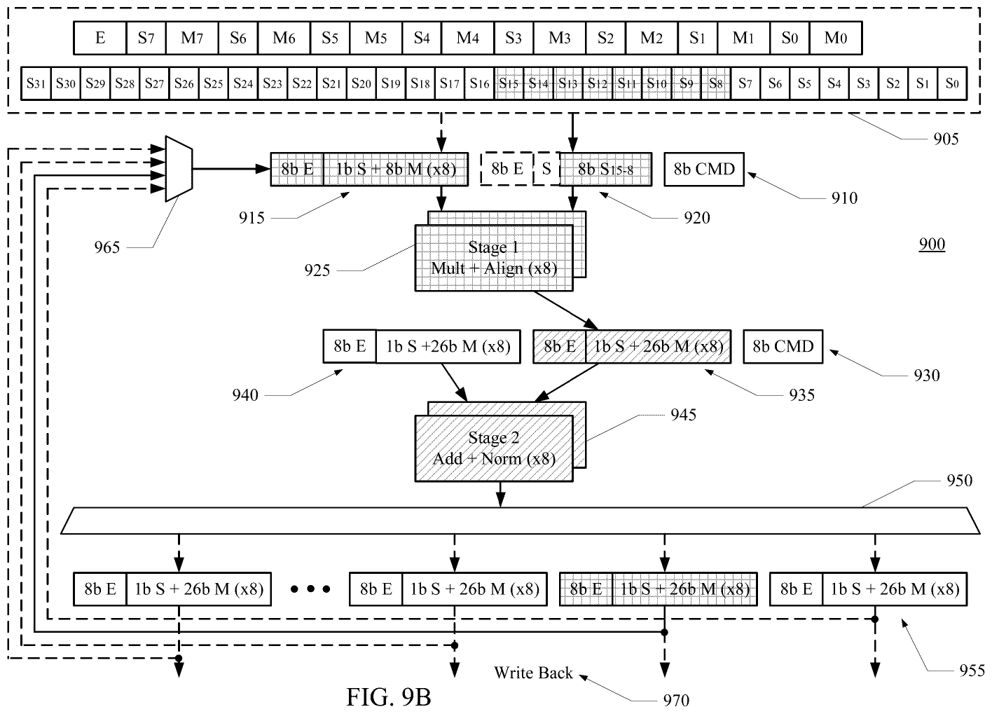

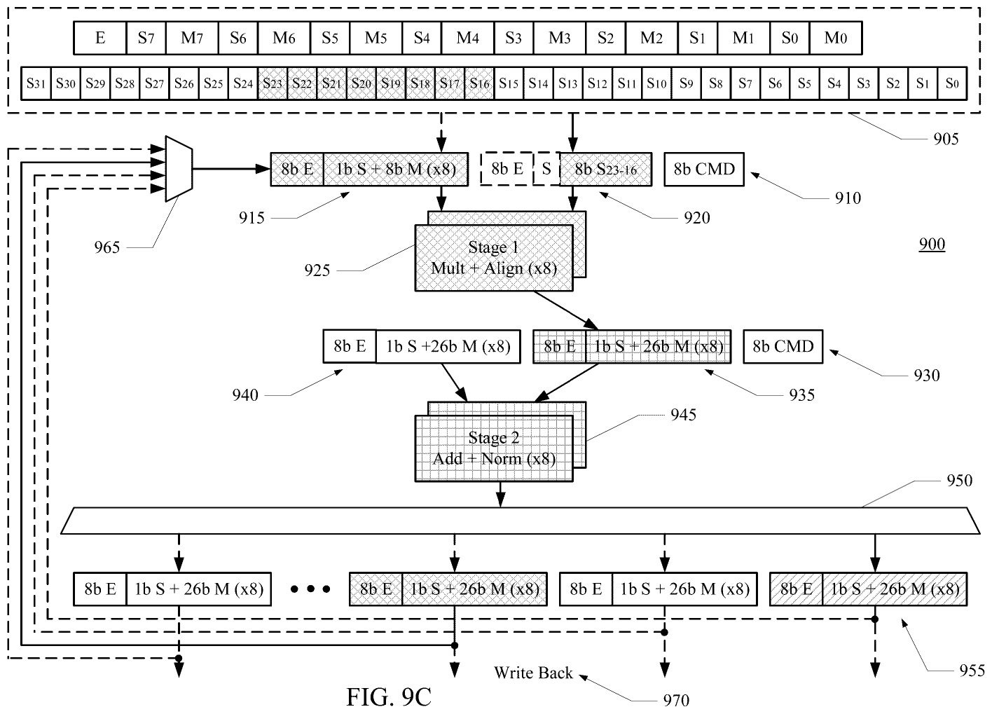

Referring now to FIGS. 9A-9C, a MAC unit for Group BF computations, in accordance with aspects of the present technology, is shown. The MAC unit 900 can be configured to scale a Group BF encoded set of values. For instance, the MAC unit 900 can be configured to multiply Group BF encoded values by scale values 905. The scaling can be performed in response to a corresponding command. In one implementation, the command can include a series of microinstructions 910 for executing computations by a plurality of multiplication and alignment units 925, and a series of microinstructions 930 for executing computations by a plurality of addition and normalization units 945.

In one implementation, the scaling can be computed on accumulation results. The accumulation results can be Group BF encoded with a common exponent of 8-bits, and a 1-bit sign and 8-bit mantissa. The scale values can each be encoded by 8-bits. The MAC unit 900 can include a set of eight multiply units with shared alignment logic 925, a set of eight accumulation units with shared normalization logic 945, associated buffers 915, 920, 935, 940, 955 and selection logic (e.g., de-multiplexor and multiplexor) 950, 965. The associated buffers are shown with separate exponent buffers, but can alternatively implement shared exponent buffers. To compute a scaling, an exponent (E), and sets of sign (S₀) and mantissa (M₀) values representing, for example, of a set of accumulation result values can be loaded 965 into a shared exponent buffer, and sets of eight sign/mantissa buffers 915. A first set of eight scale values (S₀-S₇) can be loaded into a second set of eight mantissa buffers 920. It is to be appreciated that the scale values do not include a sign or exponent. The set of multiply units with shared alignment logic 925 can compute the product of the eight accumulation result values with each of the first eight scale values in a first computation cycle (e.g., a set of one or more processing clock cycles), as illustrated in FIG. 9A.

In a second computation cycle illustrated in FIG. 9B, the first set of product values can be loaded into a corresponding first set of intermediate buffers 935. The set of accumulation units with shared normalization logic 945 can compute the accumulation of the current product values 935 with zero values during the second computation cycle. During the second computation cycle, a second set of eight accumulation result values and a second set of eight scale values (S₈-S₁₅) can be loaded into the corresponding buffers 915, 920, and the set of multiply units with shared alignment logic 925 can compute the product of the second set of eight accumulation result values with each of the second set of eight scale values.

In a third computation cycle illustrated in FIG. 9C, the first set of accumulation values (e.g., scaled values) can be loaded 950 into a corresponding first set of accumulation buffers 955. During the second computation cycle, the second set of product values can be loaded into the corresponding first set of intermediate buffers 935. The set of accumulation units with shared normalization logic 945 can compute the accumulation of the current product values 935 with zero values during the second computation cycle. During the second computation cycle, a third set of eight accumulation result values and a third set of eight weight values (S₁₆-S₂₃) can be loaded into the corresponding buffers 915, 920, and the set of multiply units with share alignment logic 925 can compute the product of the third set of eight accumulation result values with each of the third set of eight scale values.

The process can continue to scale a Group BF encoded set of values. The set of multiply units with shared alignment logic 925 can provide for shared processing of the exponent to maintain a common exponent. Similarly, the set of accumulation units with shared normalization logic 945 can provide for normalizing the accumulated values so that the leading value of 1 can be explicitly encoded using group BF encoding. Furthermore, the accumulation buffers can include one or more extra bits to provide for delayed normalization to reduce the number of times normalization is performed during multiply and accumulation cycles. After scaling the values, the resulting scaled values in the accumulation buffers 955 can be written back 970 to memory.

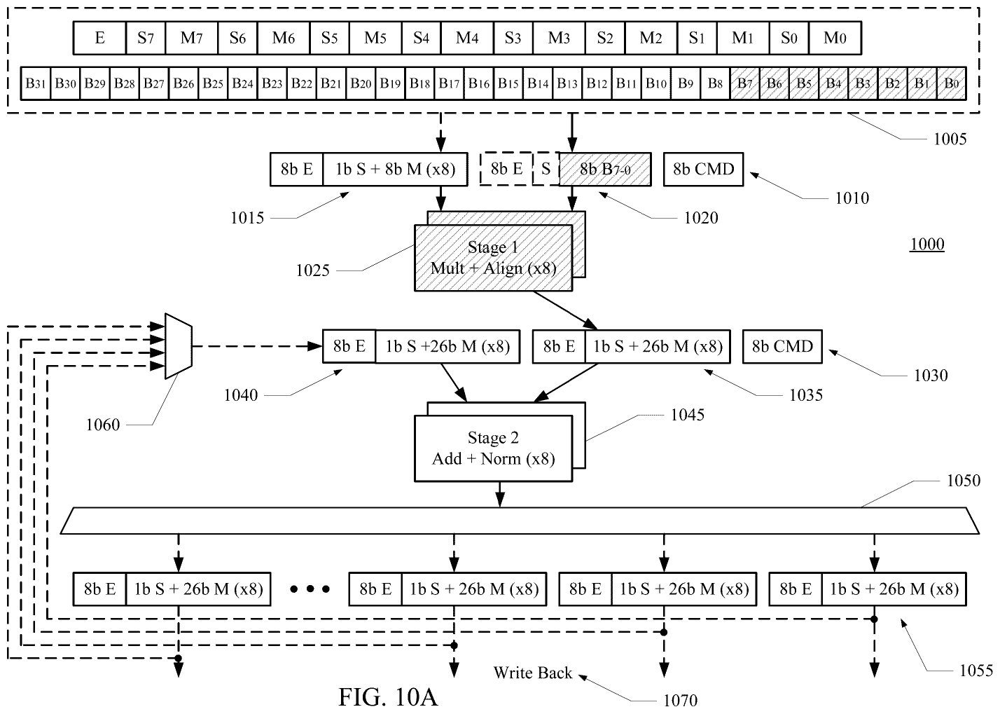

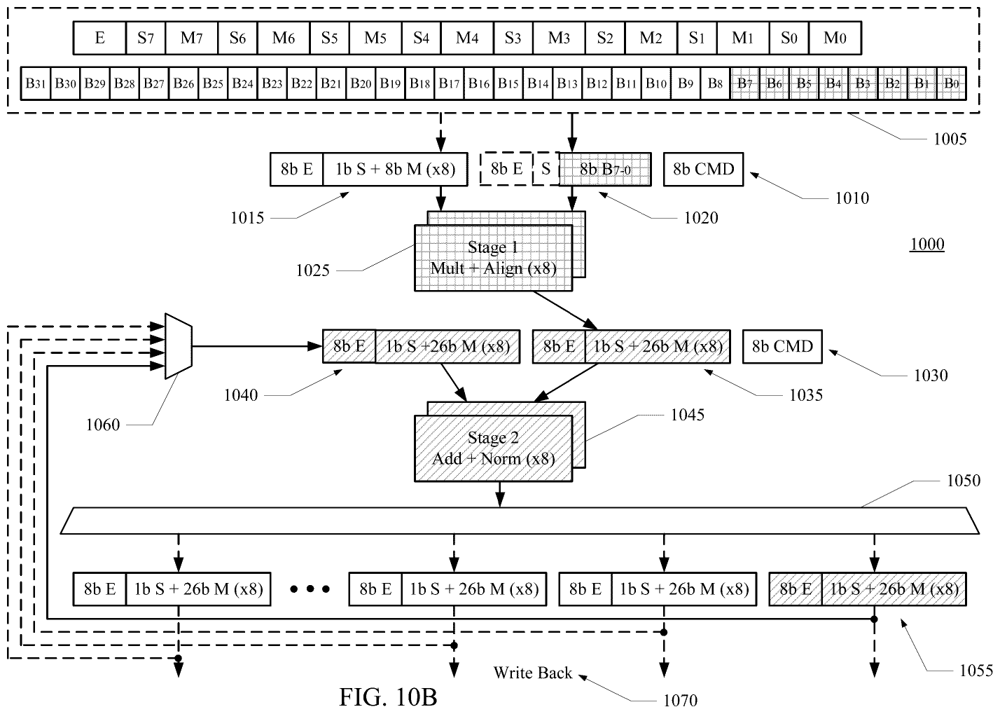

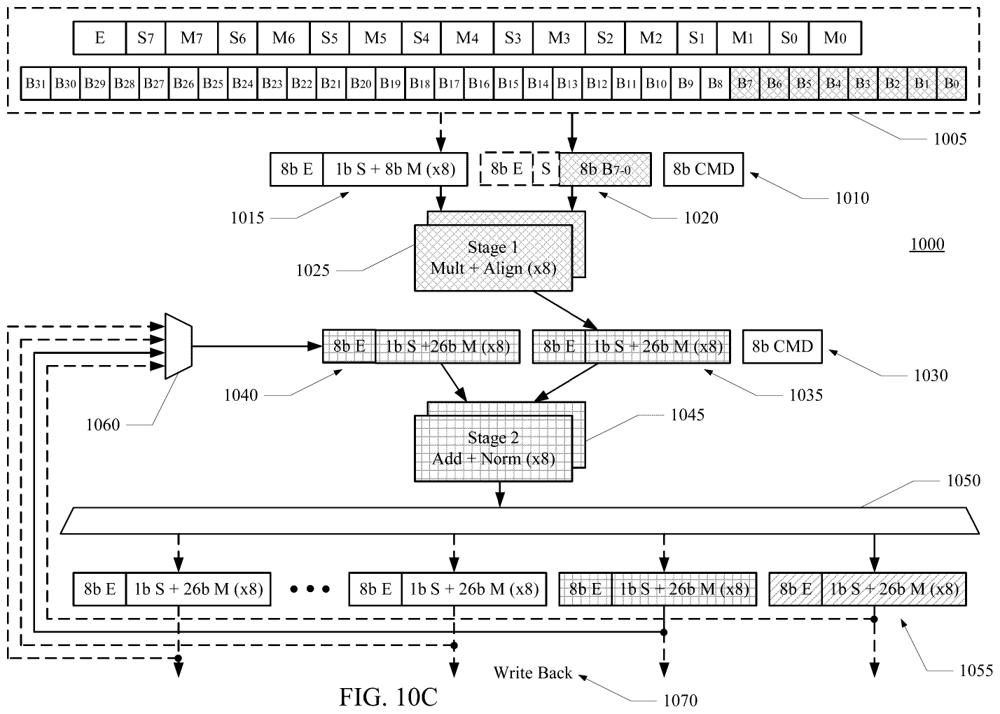

Referring now to FIGS. 10A-10C, a MAC unit for Group BF computations, in accordance with aspects of the present technology, is shown. The MAC unit 1000 can be configured to add a bias to a Group BF encoded set of values. For instance, the MAC unit 1000 can be configured to add a set of bias values 1010 to Group BF encoded values. The biasing can be performed in response to a corresponding command. In one implementation, the command can include a series of microinstructions 1010 for executing computations by a plurality of multiplication and alignment units 1025, and a series of microinstructions 1030 for executing computations by a plurality of addition and normalization units 1045.

In one implementation, the biasing can be applied to accumulation results. The accumulation results can be Group BF encoded with a common exponent of 8-bits, and a 1-bit sign and 8-bit mantissa. The bias values can each be encoded by 8-bits. The MAC unit 1000 can include a set of eight multiply units with shared alignment logic 1025, a set of eight accumulation units with shared normalization logic 1045, associated buffers 1015, 1020, 1035, 1040, 1055 and selection logic (e.g., de-multiplexor and multiplexor) 1050, 1060. The associated buffers are shown with separate exponent buffers, but can alternatively implement shared exponent buffers. To compute biasing, a first set of eight bias values (B₀-B₇) can be loaded into a second set of eight mantissa buffers 1020, during a first computation cycle. It is to be appreciated that the bias values do not include a sign or exponent. The set of multiply units with shared alignment logic 1025 can compute the product of the first eight bias values with a value of one in a first computation cycle (e.g., a set of one or more processing clock cycles), as illustrated in FIG. 10A.

In a second computation cycle illustrated in FIG. 10B, the first set of current product values (e.g., bias values) can be loaded into a corresponding first set of intermediate buffers 1035, and a first set of eight accumulation result values 1055 can be loaded 1060 into a corresponding second set of intermediate buffers 1040. The set of accumulation units with shared normalization logic 1045 can compute the accumulation of the current product values (e.g., bias values) 1035 with the first set of accumulation result values 1040 during the second computation cycle. During the second computation cycle, the first set of eight scale values (B₀-B₇) can be loaded into the corresponding buffers 1020, and the set of multiply units shared alignment logic 1025 can compute the product of each of the first set of eight bias values with a value of one.

In a third computation cycle illustrated in FIG. 10C, the first set of accumulation values (e.g., bias values) can be loaded 1050 into a corresponding first set of accumulation buffers 1055. During the second computation cycle, the second set of product values can be loaded into the corresponding first set of intermediate buffers 1035, and a second set of eight accumulation result values 1055 can be loaded 1060 into the corresponding second set of intermediate buffer 1040. The set of accumulation units with shared normalization logic 1045 can compute the accumulation of the current product values (e.g., bias values) 1035 with the second set of accumulation result values 1040 during the third computation cycle. During the third computation cycle, the first set of eight scale values (B₀-B₇) can be loaded into the corresponding buffers 1020, and the set of multiply units with shared alignment logic 1025 can compute the product of each of the first set of eight bias values with a value of one.

The process can continue for biasing the accumulation result values 1055. The set of multiply units with shared alignment logic 1025 can provide for shared processing of the exponent to maintain a common exponent. Similarly, the set of accumulation units with shared normalization logic 1045 can provide for normalizing the accumulated values so that the leading value of 1 can be explicitly encoded using group BF encoding. Furthermore, the accumulation buffers can include one or more extra bits to provide for delayed normalization to reduce the number of times normalization is performed during multiply and accumulation cycles. After the biasing of the accumulation result values 1055 is completed the biased accumulated result values in the accumulation buffers 1055 can be written back 1070 to memory.

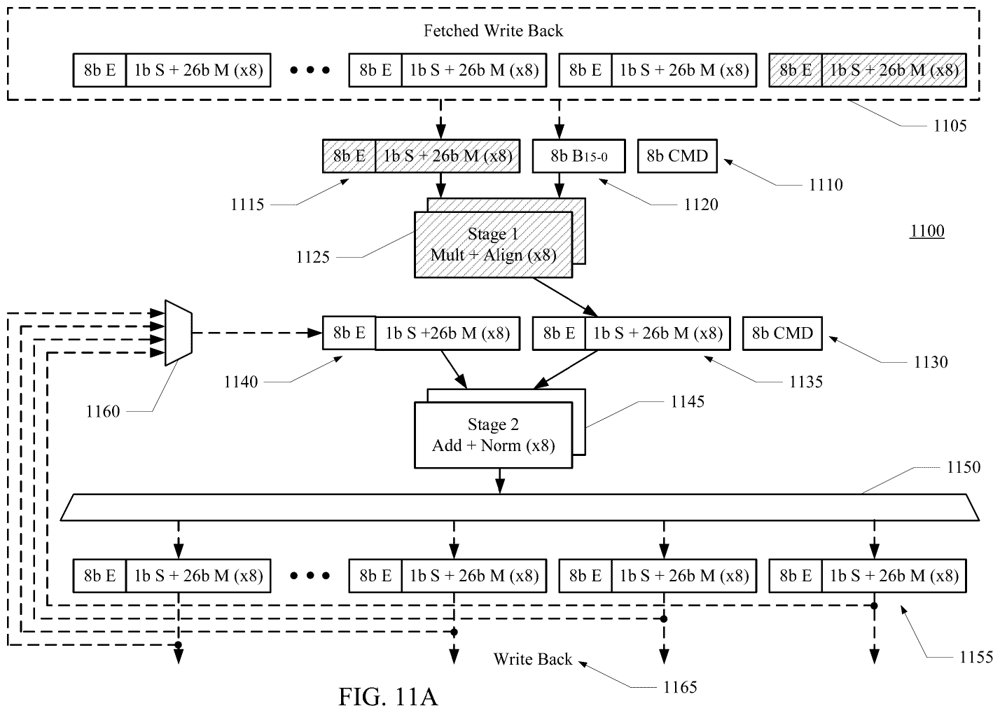

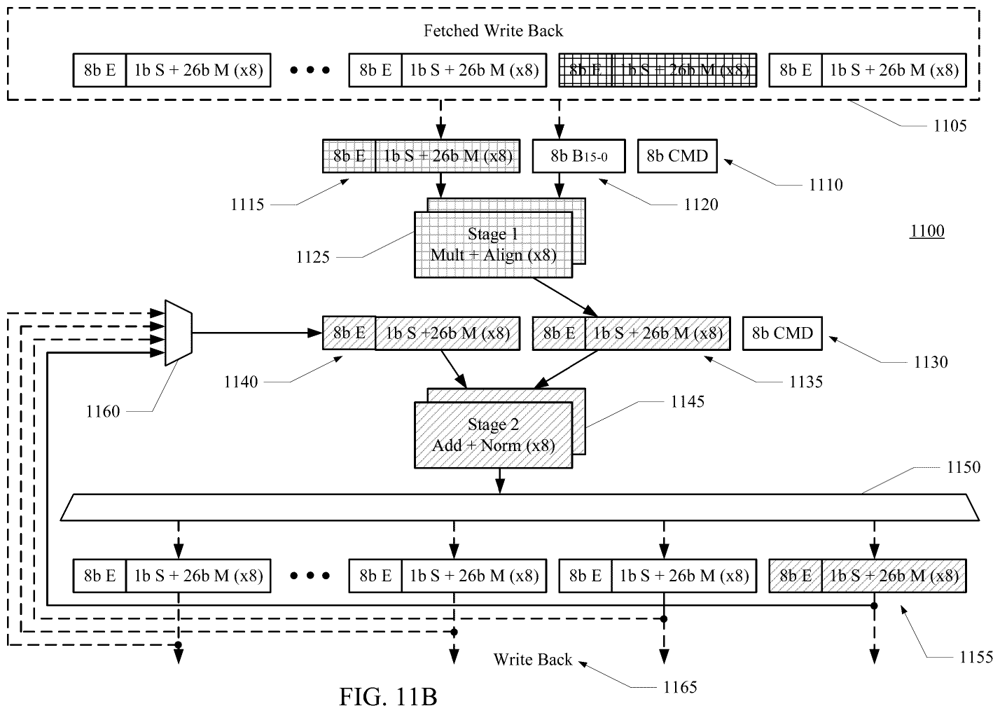

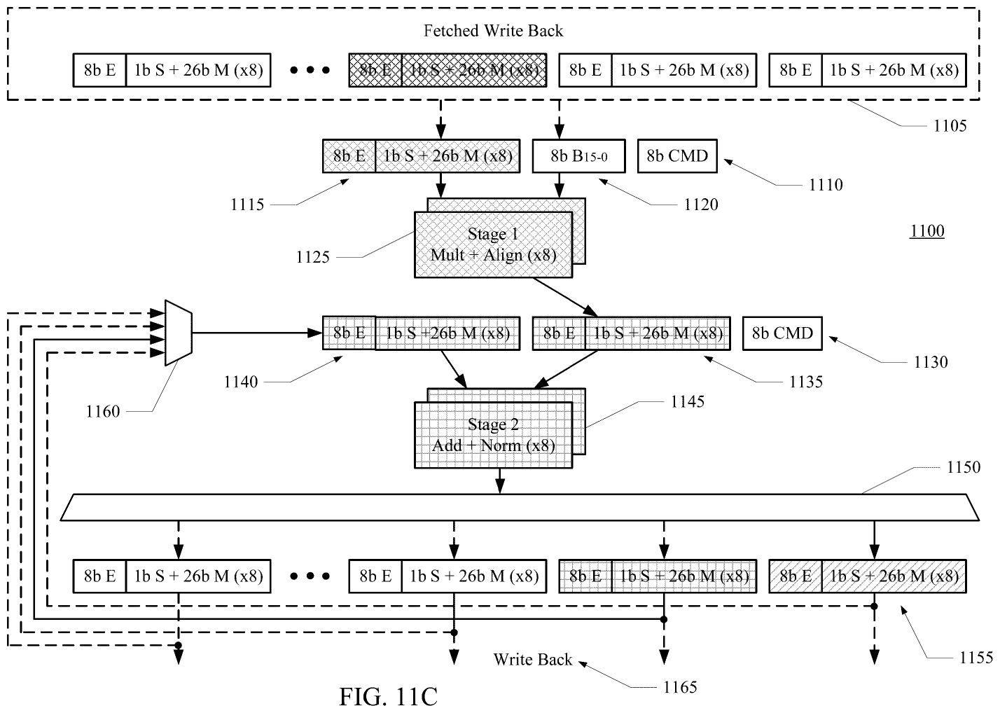

Referring now to FIGS. 11A-11C, a MAC unit for Group BF computations, in accordance with aspects of the present technology, is shown. The MAC unit 1100 can be configured to loopback add Group BF encoded set of values. Loopback adding can be utilized for computations such as but not limited to average pooling. Average pooling can be utilized for determining the average value of regions for down sampling data commonly utilized in convolution neural network processing. For instance, the MAC unit 1100 can be configured to add current accumulated result values 1155 to fetched write back Group BF encoded values 1105. The loopback adding can be performed in response to a corresponding command. In one implementation, the command can include a series of microinstructions 1110 for executing computations by a plurality of multiplication and alignment units 1125, and a series of microinstructions 1130 for executing computations by a plurality of addition and normalization units 1145.

In one implementation, accumulation results can be added to an average pooling. The average pooling can be Group BF encoded with a common exponent of 8-bits, and a 1-bit sign and 26-bit mantissa. Likewise, the accumulation values can be Group BF encoded with a common exponent of 8-bits, and a 1-bit sign and 26-bit mantissa. The MAC unit 1100 can include a set of eight multiply units with shared alignment logic 1125, a set of eight accumulation units with shared normalization logic 1145, associated buffers 1115, 1120, 1135, 1140, 1155 and selection logic (e.g., de-multiplexor and multiplexor) 1150, 1160. The associated buffers are shown with separate exponent buffers, but can alternatively implement shared exponent buffers. To compute average pooling, previous average pooling values can be fetched (e.g., previous write back values can be fetched) and loaded into a shared exponent buffer, and sets of eight sign/mantissa buffers 1115. The set of multiply units with shared alignment logic 1125 can compute the product of the first eight average pooling values with a value of one in a first computation cycle (e.g., a set of one or more processing clock cycles), as illustrated in FIG. 11A.

In a second computation cycle illustrated in FIG. 11B, the first set of current product values (e.g., previous average pooling values) can be loaded into a corresponding first set of intermediate buffers 1135, and a first set of eight accumulation result values 1155 can be loaded 1160 into a second set of intermediate buffers 1140. The set of accumulation units with shared normalization logic 1145 can compute the accumulation (e.g., addition) of the current product values (e.g., average pooling values) 1135 with the first set of accumulation result values 1155 during the second computation cycle. During the second computation cycle, a second set of eight previous average pooling values can be loaded into the corresponding buffers 1115, and the set of multiply units 1125 can compute the product of each of the second set of previous average pooling values with a value of one.

In a third computation cycle illustrated in FIG. 11C, the first set of accumulation values (e.g., current average pooling values) can be loaded in 1150 into a corresponding first set of accumulation buffer 1155 During the third computation cycle, the second set of current product values (e.g., previous average pooling values) can be loaded into the corresponding first set of intermediate buffers 1135, and a second set of eight accumulation result values 1155 can be loaded 1160 into the second set of intermediate buffers 1140. The set of accumulation units with shared normalization logic 1145 can compute the accumulation of the current product values (e.g., previous average pooling values) 1135 with the second set of accumulation result values 1155 during the third computation cycle. During the third computation cycle, a third set of set of previous average pooling values can be loaded into the corresponding buffers 1115 and the set of multiply units 1125 can compute the product of each of the third set of eight previous average pooling values with a value of one.

The process can continue for computing current average pooling values 1155. The set of multiply units with shared alignment logic 1125 can provide for shared processing of the exponent to maintain a common exponent. Similarly, the set of accumulation units with shared normalization logic 1145 can provide for normalizing the accumulated values so that the leading value of 1 can be explicitly encoded using group BF encoding. Furthermore, the accumulation buffers can include one or more extra bits to provide for delayed normalization to reduce the number of times normalization is performed during multiply and accumulation cycles. After computing the current average pooling values 1155 is completed the current average pooling values in the accumulation buffers 1155 can be written back 1165 to memory.

Aspects of the present technology can advantageously reduce processing latency, energy consumption and the like in systems from smart phones to massive data centers where is a continuing need to improve the performance of processing units such as the MAC units. MAC units, in accordance with aspects of the present technology, can advantageously be configured to directly load group BF encoded values to eliminate the conversion of group BF values to conventional floating point encoded values, thereby reducing processing energy consumption and reducing processing latency. The MAC units can also include shared exponent processing that can advantageously reduce the size of the exponent buffers throughout the MAC unit. The MAC units can also include a plurality of multiply units with shared alignment logic that can advantageously reduce the size of the plurality of multiply units. The MAC units can also include a plurality of accumulation units with shared normalization logic that can advantageously reduce the size of the plurality of accumulation units. The MAC units can also implement delayed normalization by the plurality of accumulation units with shared normalization logic that can advantageously reduce processing energy consumption and reduce processing latency.

In accordance with aspects of the present technology, the MAC units can be configured to multiply a set of group BF encoded values of the with corresponding sets of a plurality of weights to compute a regular convolution of the pixels and the weights. The MAC units can also be configured to multiply the set of group BF encoded values of the with corresponding sets of a plurality of weights to compute a regular convolution of the pixels and the weights. The MAC units can also be configured to multiply corresponding BF encoded accumulation results with corresponding sets of a plurality of scale values to compute corresponding BF encoded scaled accumulation results. The MAC units can also be configured to multiply corresponding BF encoded accumulation results with corresponding sets of a plurality of bias values to compute corresponding BF encoded biased accumulation results. The MAC units can also be configured to accumulate corresponding BF encoded previous accumulation results with corresponding BF encoded current accumulation results to compute loopback adding.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is intended that the scope of the invention be defined by the claims appended hereto and their equivalents.

1. A multiply and accumulation (MAC) unit comprising:
a first plurality of buffers including a plurality of sign buffers, a plurality of mantissa buffers and a shared exponent buffer to directly receive sets of group brain float (BF) encoded values;
a plurality of multiplication units to perform multiplication computations on sets of BF encoded values of the sets of group BF encoded values in the first plurality of buffers to produce corresponding BF encoded products;
a plurality of accumulation units to perform accumulation computations on sets of the corresponding BF encoded products to produce corresponding BF encoded accumulation results.

2. The MAC unit of claim 1, wherein the corresponding BF encoded accumulation results are directly output by the MAC unit as a corresponding group BF encoded accumulation value.

3. The MAC unit of claim 1, further comprising:
an alignment logic utilizing the share exponent buffer to maintain a common exponent value of the corresponding BF encoded products.

4. The MAC unit of claim 3, wherein the alignment logic is shared by the plurality of multiplication units.

5. The MAC unit of claim 1, further comprising:
a normalization logic to normalize the sets of the corresponding BF encoded products.

6. The MAC unit of claim 5, wherein:
one or more of the mantissa buffers include one or more extra bits; and
the normalization logic, utilizing the one or more of the mantissa buffers including one or more extra bits, is configured to delay normalization for one or more normalization computation cycles.

7. The MAC unit of claim 5, wherein the normalization logic is shared by the plurality of multiplication units.

8. The MAC unit of claim 1, further comprising:
wherein the sets of BF encoded values of the set of group BF encoded values comprise pixels;
a second plurality of buffers including a plurality of weight buffers to receive a plurality of weights; and
the plurality of multiplication units to further perform multiplication computations on the set of group BF encoded values of the pixels with corresponding sets of the plurality of weights wherein the MAC unit computes a regular convolution of the pixels and the plurality of weights.

9. The MAC unit of claim 1, further comprising:
wherein the sets of BF encoded values of the set of group BF encoded values comprise pixels;
a second plurality of buffers including a plurality of weight buffers to receive a plurality of weights; and
the plurality of multiplication units to further perform multiplication computations on the set of group BF encoded values of the pixels with corresponding sets of the plurality of weights wherein the MAC unit computes a depthwise convolution of the pixels and the plurality of weights.

10. The MAC unit of claim 1, further comprising:
a second plurality of buffers including a plurality of scale buffers to receive a plurality of scale values; and
the plurality of multiplication units to further perform multiplication computations on the corresponding BF encoded accumulation results with corresponding sets of the plurality of scale values wherein the MAC unit computes corresponding BF encoded scaled accumulation results.

11. The MAC unit of claim 1, further comprising:
a second plurality of buffers including a plurality of bias buffers to receive a plurality of bias values; and
the plurality of accumulation units to further perform accumulation computations on the corresponding BF encoded accumulation results with corresponding sets of the plurality of bias values wherein the MAC unit computes corresponding BF encoded biased accumulation results.

12. The MAC unit of claim 1, further comprising:
the first plurality of buffers to further receive corresponding BF encoded previous accumulation results; and
the plurality of accumulation units to further perform accumulation computations on the corresponding BF encoded previous accumulation results with corresponding BF encoded current accumulation results wherein the MAC unit computes loopback adding.

13. A multiply and accumulation (MAC) method comprising:
directly receiving group brain float (BF) encoded values;
multiplying sets of the BF encoded values of the group BF encoded values to produce corresponding BF encoded products;
accumulating the corresponding BF encoded products to produce corresponding BF encoded accumulation results.

14. The MAC method of claim 13, further comprising outputting the corresponding BF encoded accumulation results as a corresponding group BF encoded accumulation result.

15. The MAC method of claim 13, wherein exponents of the sets of the BF encoded values, the corresponding BF encoded products and the BF encoded accumulation results are shared.

16. The MAC method of claim 13, wherein the corresponding BF encoded products are aligned during multiplying.

17. The MAC method of claim 13, wherein the corresponding BF encoded accumulation results are normalized during multiplying.

18. The MAC method of claim 17, wherein normalization of the corresponding BF encoded accumulation results is delayed for one or more cycles of accumulating the corresponding BF encoded products.

19. The MAC method of claim 13, further comprising:
wherein the sets of BF encoded values of the sets of group BF encoded values comprise pixels;
multiplying the sets of group BF encoded values of the pixels with corresponding sets of a plurality of weights to compute a regular convolution of the pixels and the weights.

20. The MAC method of claim 13, further comprising:
wherein the sets of BF encoded values of the sets of group BF encoded values comprise pixels;
multiplying the sets of group BF encoded values of the pixels with corresponding sets of a plurality of weights to compute a depthwise convolution of the pixels and the weights.

21. The MAC method of claim 13, further comprising:
multiplying the corresponding BF encoded accumulation results with corresponding sets of a plurality of scale values to compute corresponding BF encoded scaled accumulation results.

22. The MAC method of claim 13, further comprising:
accumulating the corresponding BF encoded accumulation results with corresponding sets of a plurality of bias values to compute corresponding BF encoded biased accumulation results.

23. The MAC meth of claim 13, further comprising:
accumulating corresponding BF encoded previous accumulation results with corresponding BF encoded current accumulation results to compute loopback adding.
